(19) United States
(12) Patent Application Publication
(10) Pub. No.: US 2012/0029706 A1
(43) Pub. Date: Feb. 2, 2012

(54) Simulation-Supported Method for Controlling and Regulating Compressed Air Stations

(75) Inventors: Florian Wagner, Mainz (DE); Georg Frey, Kaiserslautern (DE)

(73) Assignee: Kaeser Kompressoren GmbH, Coburg (DE)

(21) Appl. No.: 13/141,233

(22) PCT Filed: Dec. 23, 2009
(86) PCT No.: PCT/EP2009/067838

§ 371 Date: Sep. 12, 2011

(30) Foreign Application Priority Data
Dec. 23, 2008 (DE) 10 2008 064 491.9

(51) Int. Cl. G05D 7/06

(52) U.S. Cl. 700/282

(57) ABSTRACT

The invention relates to a method for controlling and/or regulating a compressed air station comprising at least one plurality of interconnected compressors, optionally having different technical specifications, and further optional compressed air system devices, which is optionally able to implement control cycles as well as switching strategies by means of an electronic system controller to influence the amount of a pressurized fluid in the compressed air station available at all times to one or more consumers of the compressed air station as well as adaptively adjust the amount of pressurized fluid available at all times to one or more consumers of the compressed air station to the future operating conditions of the compressed air station based on the amount of pressurized fluid withdrawn from the compressed air station, wherein before a switching strategy is initiated, different switching strategies are analyzed in a prior simulation method based on a model of the compressed air station and the comparatively most advantageous switching strategy is selected from among the analyzed switching strategies on the basis of at least one fixed performance criterion and the selected switching strategy is relayed to the system controller for implementing in the compressed air station.

The invention relates to a method for controlling and/or regulating a compressed air station comprising at least one plurality of interconnected compressors, optionally having different technical specifications, and further optional compressed air system devices, which is optionally able to implement control cycles as well as switching strategies by means of an electronic system controller to influence the amount of a pressurized fluid in the compressed air station available to one or more consumers of the compressed air station, as well as adaptively adjust the amount of pressurized fluid available to one or more consumers of the compressed air station to the future operating conditions of the compressed air station based on the amount of pressurized fluid withdrawn from the compressed air station.

The present invention further relates to a method for controlling and/or regulating a compressed air station comprising at least one plurality of interconnected compressors, optionally having different technical specifications, and further optional compressed air system devices, wherein the method, which is implemented in an electronic controller for a compressed air station, processes information about essential compressed air station status variables as input information and emits control commands as output to control at least some compressors and further optional components of the compressed air station in accordance with the precharacterizing part of claim 34.

The present invention moreover relates to a controller for a compressed air station.

The use of compressed air stations has become established in many industries as well as private environments. The provision of larger amounts of pressurized fluid is not only indispensable for example to operate hydraulic equipment in industrial manufacturing facilities, but also to provide pressurized fluid for chemical reactions as well as the physical manufacturing sites making use of same. Compressed air stations, which typically comprise at least one plurality of compressors, pressurized fluid containers and the associated control means and actuators, often require a sophisticated and usually complicated control able to provide sufficient pressurized fluid to a potentially large number of consumers at different receiving stations of the compressed air station at any desired time. For example, valves are opened or closed in response to different switching operations, in consequence of which pressurized fluid is increased or decreased to specific areas of the compressed air station and the supply of sufficient pressurized fluid to the consumers can be ensured. Further conceivable switching operations relate to, for example, also the connecting or disconnecting of individual compressors or groups of compressors or, in contrast to discrete connecting and disconnecting, also a continuous regulating of individual actuators or control means.

In order to be able to effect an advantageous control of the compressed air station, the controller for the compressed air station needs information about the status of the compressed air station. Such information can be fixed system parameters predetermined by the compressed air station as well as measurable status variables such as e.g. the pressure or even discrete or informational status variables such as e.g. the operating mode of a compressor (stopped, no-load running, load running) which allows conclusions to be drawn about the status of the compressed air station at a specific point in time. Desirable or sometimes also vital basic conditions which need to be observed when operating the compressed air station furthermore need to be taken into account when controlling the compressed air station. These include specifications as to compliance with maximum allowable pressures in the pressurized line as well as the pressurized fluid container network of the compressed air station, as well as specifications on the minimum pressure that needs to be maintained at consumer connecting stations.

A number of control and/or regulating methods used to control compressed air stations are already known in the prior art. A relatively simple control method uses a cascade connection which assigns each compressor a predetermined band of pressure. A compressor is switched on upon falling below the lower pressure band limit. Upon exceeding the upper pressure band limit, a compressor is correspondingly switched off. Overlapping different pressure bands for the individual compressors comprised by the compressed air station allows for the adjusting of a minimum pressure which enables the consumers of the compressed air station to withdraw a desired amount of pressurized fluid from the system.

Other control methods use a sequential control requiring a common predetermined band of pressure. Falling outside of the limits of the pressure band correspondingly switches compressors on or off in a predefined order. A timer is started upon each switching operation which measures a predetermined interval of time. Should the pressure prevailing in the compressed air station not have reached the pressure regime predefined for the pressure band before the end of this interval, further compressors are in turn switched on or off in a predefined order.

A further development of sequential control is based on pressure band control. Instead of the relatively inflexible on/off switching of individual compressors, compressors are switched on and off in predetermined sequences of groups. The switched compressors within a group are selected based on heuristic rules which, over time, have proven themselves suitable to minimizing the operating costs of a compressed air station.

All these methods for controlling compressed air stations are wholly process-driven. Accordingly, switching operations on the actuators comprised by the compressed air station as well as the compressors are only effected as a reaction to predefined compressed air events occurring in the compressed air station. Thus, each compressed air station control action here is only a reaction to an event occurring in the present or which occurred in the past. The pressurized fluid ratios in the compressed air station cannot be re-regulated until the event has been appropriately ascertained. The control response therefore always occurs only upon an event which, had the compressed air station been optimally controlled, should have been averted.

In order to be able to prompt switching operations in sufficient time to counter an impending event which has already become apparent, some known prior art control methods use a large number of interconnected pressure bands. The different pressure areas defined by the individual pressure bands also allow the early detecting of changes in the pressure conditions as possibly having only just been identified and promptly countering any exceeding or falling short of a maximum or minimum pressure in the compressed air station with the applicable switching operations. Yet also methods such as these can be regarded as purely reactive control methods since the associated control operation does not occur until there are predetermined pressure conditions in the compressed air station.

The regulating operations performed in the depicted control methods still need to take the reaction time of all the control elements into account in order to prevent overreacting to a corresponding control operation in the compressed air station. Accordingly, new control operations are only calculated after a typical delay time contingent on the reaction time of the control elements. Yet doing so cannot avoid the effect of a control operation only being able to be observed upon re-assessing of the compressed air station status and a new reaction being calculated by further control operations. As a result, the control reaction time is artificially reduced, which adversely impacts the quality of the control of the compressed air station.

The known prior art control methods moreover only allow a consideration of basic conditions to the extent that same can be explicitly factored into the parameterization of the control calculations. However, the correlations between numerous physical compressed air station variables can only be parameterized by indicating empirical rules which only represent purely heuristic conditions in furthermore potentially extremely limited pressure regimes. It is for example known that in many cases (not all), energy can be saved by lowering the compressed air station's maximum allowable pressure. Switching on or off small before large compressors or groups of compressors has furthermore been advantageous in lowering energy costs. Yet implementing such recognitions in a control method for compressed air stations becomes very difficult, and in many cases impossible, since there can be opposing effects to the influencing basic conditions due to the overlapping of different parameter settings, whereby heuristic parameterization poses undesirable complications for the system operator.

The present invention is now based on the object of proposing a control method for compressed air stations which eliminates the disadvantages of the known prior art solution approaches. The inventive control method is to optionally allow the earliest possible anticipating of pressure changes in the compressed air station so as to engineer the appropriate switching operations.

This object is achieved by a method for controlling a compressed air station in accordance with claims 1 and 35, respectively by a controller of a compressed air station in accordance with claim 37.

The object is optionally achieved by a method for controlling a compressed air station which comprises at least one plurality of interconnected compressors, optionally having different technical specifications, and further optional compressed air system devices, which is optionally able to prompt control cycles as well as circuit strategies by means of an electronic controller to influence an amount of a pressurized fluid in the compressed air station which is available at all times to one or more consumers of the compressed air station, as well as adaptively adjust the amount of pressurized fluid available to one or more consumers of the compressed air station to the future operating conditions of the compressed air station based on the amount of pressurized fluid withdrawn from the compressed air station, whereby before initiating a switching strategy, a prior simulation method checks switching strategies based on a model of the compressed air station and selects the comparatively most advantageous switching strategy from the switching strategies analyzed on the basis of at least one fixed performance criterion and the selected switching strategy is relayed to the controller for implementing in the compressed air station.

It is hereby to be pointed out that the compressors as well as the other compressed air system devices optionally incorporated into the compressed air station do not have to be regulated or controlled exclusively by the controller but can instead be regulated or controlled by partial aspects (e.g. safety cut-offs, running simple switching sequences after external control parameters have changed), also by internal control or regulating mechanisms.

The object is moreover achieved by a method for controlling or regulating a compressed air station comprising at least one plurality of interconnected compressors, optionally having different technical specifications, and further optional compressed air system devices, wherein the method, which is implemented in an electronic control of a compressed air station, processes information about essential compressed air station status variables as input information and emits as output control commands to control at least some compressors and further optional components of the compressed air station, wherein the method exhibits the following functional structures: a simulation kernel which contains dynamic and preferably non-linear models of at least some components of the compressed air station in order to specify the response of these components, wherein the simulation kernel is configured such that it precalculates the variation of all the status variables of the compressed air station components contained in the model over time as simulation results on the basis of the accepted alternative switching strategies, wherein the models of the simulation kernel factor in the essential nonlinearities and/or discontinuities and/or reaction times of component response, optionally that of the compressors; an algorithm kernel containing the parameters to characterize the components of the compressed air station, circuitry information on the individual components, heuristics for configuring alternative switching strategies and evaluation criteria for the variation over time in the status variables of the compressed air station components as determined by the simulation kernel for the alternative switching strategies and which selects the comparatively most advantageous switching strategy on this basis and which holds ready or relays associated control commands to at least some compressors; and an information base which in addition to a process image furnished from the sensor values and from the algorithm kernel as applicable, also contains the simulation results for alternative switching strategies, wherein the information base represents at least a portion of the common database of the algorithm and simulation kernels and serves in the exchanging of data between the algorithm and simulation kernels.

In accordance with the embodiment, the information base can contain a process image of the compressed air station; i.e. essentially the measured values for the status variables and the current control parameters, supplemented by the prior simulation results on the status variables over time for different scenarios. The algorithm kernel can further contain information on the configuration of the compressed air station as well as the types of components contained therein and their parameters. It can also comprise heuristics for configuring different scenarios to analyze. The algorithm kernel then typically relays this information to the simulation kernel. The algorithm kernel typically also relays the status information of the compressed air station originating from the information base and relevant to the prior simulation to the simulation kernel. The simulation kernel can hereby comprise models for the usual components of the compressed air station. It is furthermore able to form a model of the compressed air station from these models using the information received from the algorithm kernel on the structure of the compressed air station and the components contained therein and their parameters which it completes with further information on the current status of the compressed air station from the information base. Based on this, the simulation kernel can typically simulate all the variations over time of the status variables of the model of the compressed air station during the prior simulation period and store same in the information base. The simulation kernel can moreover furnish the algorithm kernel with status reports associated with running the prior simulations.

On the basis of the alternative variations over time of all the status variables of the model of the compressed air station stored in the information base, the algorithm kernel can further evaluate same for the scenarios being analyzed and select the comparatively most advantageous scenario pursuant the performance index and communicate the respective switching strategies to the components of the compressed air station, respectively hold these switching strategies ready for retrieval. Hence, the simulation kernel can be used as a relatively extensive and complicated part of implementation independent of the physical compressed air station, i.e. universally applicable. Logically, the modeling and specifying can also ensue with object-oriented software methods.

The object is further achieved by a controller fora compressed air station which comprises a plurality of interconnected compressors, optionally having different technical specifications, and further optional compressed air system devices, which is able to prompt control elements of the compressed air station and/or different compressors, optional control cycles as well as switching strategies, to influence the amount of a pressurized fluid in the compressed air station which is available to one or more consumers of the compressed air station at all times, as well as adaptively adjust the amount of pressurized fluid available at all times to one or more consumers of the compressed air station to the future operating conditions of the compressed air station based on the amount of pressurized fluid withdrawn from said compressed air station, wherein prior to performing a switching strategy, different switching strategies are analyzed in a real-time prior simulation method based on a model of the compressed air station and a comparatively advantageous switching strategy is selected from said switching strategies based on at least one fixed performance criterion and the controller generates a switching command based on the selected switching strategy.

One of the main principles on which the invention is based is that of calculating different switching strategies, roughly comparable different switching operation scenarios, using a prior simulation method which correspondingly allows simulating the behavior of the entire compressed air station, respectively also the individual subcomponents thereof. Accordingly, no optimization calculation is run which would mathematically optimize for instance the value of a compressed air station-specified functional; instead only a number of scenarios for different compressed air station conditions are defined.

According to one scenario, an assumed or predicted development of disturbance variables, optionally compressed air consumption, is to be understood here in conjunction with a switching strategy to be analyzed. A switching strategy is further to be understood as a sequence of switching operations; i.e. a discrete or continuous changing of control parameters which can cause a change in the operation of one or more of the compressed air station components. To this end, the calculation for instance involves switching between load running and no-load running or stopped status as well as consecutive or continuous changes in compressor rotational speed or air regulator or discharge condition, and also includes changes in parameter settings for the compressor or other optional components of the compressed air station.

Switching operations are moreover not only to be understood as individual discrete switching actions in the following, but rather also as a staggered succession of switching actions in the sense of a switching strategy. In addition, the term switching operation comprises not only discrete changes in component operating condition (for example switching between stopped, no-load running and load running mode), but rather also continuous changes, for example the change over time in rotational speed of a variable-speed compressor or the continuous closing or opening of valves.

A clear advantage of the method according to the invention versus methods based on optimizing a functional specifying a compressed air station in order to effect optimum control of the compressed air station over a predetermined period of time is related to the fact that it is relatively easy to implement complex, non-linear, time-based models, possibly even discontinuous models if need be, because mathematical methods do not need to be used to bring the implemented models into an analytical form to develop an optimization calculation to determine optimum control parameters. Even optimization calculation-coupled limitations, for instance continuous disturbance and control parameters in one time step, do not constitute limitations to the inventive method.

The prior simulation method according to the invention is thereby implemented on the basis of a model of the compressed air station which can be parameterized and specified according to the number and type of components implemented in the model of the compressed air station. Parameters typically refer to characteristics which specify the design-related properties (thus in the present case, for instance, the number of pressurized containers, actuators or compressors, electrical properties of the drive motors, line and pressurized container volume, the condition of the compressed air station's pressure lines, etc.) or the given settings (programmed switching delays, etc.) and are integrated into the modeling. While parameters typically do not exhibit any temporal change, they can, however, be updated under certain circumstances and/or adaptively adjusted in order to take into account wear of individual components, for instance.

Apart from parameters, models also require status variables which are the current values of individual components or the physical procedures characterizing the compressed air station to structurally or also functionally specify the devices.

Among that calculated is for instance the electrical capacity, the pressure volume flow produced, internal pressures, rotational speed of drive motors, compressor elements or fan motors, actuator settings and the like. However, it needs to be emphasized at this point that compressors exhibit some relevant status variables, the values of which do not yield from the current values for disturbance or control parameters but rather from past variations in time, which is why suitable models also need to factor in past events. Therefore, a dynamic approach with “memory” is advantageous when creating a model of the compressed air station or of individual components, an approach which is particularly easy to realize with the method according to the invention.

The design of models to characterize the compressed air station or individual components thereof is seen to be extremely advantageous particularly in the case of an object-oriented implementation. The prior simulation methods applied in these models can additionally be implemented largely independent of the actual compressed air station structure, respectively the model created for it.

The prior simulation method results typically include the variations over time of preferably all the status variables of compressors or other compressed air system devices optionally included in the compressed air station contained in a model. This includes for instance variations over time in the compressed air station status variables specified in the selected model over the prior simulation period, for example pressure profiles, electrical capacities, compressed air flow rates, rotational speed of driving motors, compressor elements or fan motors or internal actuator settings. These results are subsequently evaluated for each alternative switching strategy based on a performance criterion, whereby a preferential order can be established. The switching strategy which ultimately comes first in the preferential order from the plurality of analyzed switching strategies is selected as the comparatively most advantageous switching strategy and accordingly held ready or initiated. A switching strategy selected as the comparatively most advantageous does not hereby need to be maintained all the way through to the end of the prior simulation period but in fact can be replaced as early as the next control cycle by any greater advantageous switching strategy as applicable. The duration of the prior simulation strategy taken into account during the evaluating of the performance criterion can also be variable and, if needed, adjusted by the control method, optionally adaptively, to the course of disturbance variables, control parameters and/or status parameters.

An essential point of the invention is also further related to the control or regulating method applicably factoring in time delays (reaction times) or erratically changing status variables (discontinuities) in the prior simulation, for instance a rapid dispensing of a compressor's compressed air after switching from stopped mode or no-load running into load running. Due to the reaction times and discontinuities which occur, the time delays of which can last longer than the control cycles, not only do the effects of switching operations at the beginning of the current control cycle on the course of the status variables in a current control cycle need to be considered but also the effects of switching operations during control cycles as well as in past control cycles and future control cycles. This type of chronologically integral approach is particularly easy to realize with the present method. Only this type of approach will enable a realistic and highly-accurate simulated modeling of compressed air stations; i.e. optionally its pressure profile and energy use.

Unlike with the known control and regulating methods, the present control and regulating method can thus also analyze switching strategies having switching operations during the prior simulation period. This thereby also allows identifying the comparatively most advantageous time for specific switching operations to run. The inventive method further has the major advantage of being able to consider variable chronological profiles of disturbance variables during the prior simulation period. By applying the appropriate prognoses to the disturbance variables, for example the chronological profile of the compressed air withdrawn from the compressed air station, better accuracy is enabled for prior simulation over a longer period of time and thus also a better evaluation of the effects of switching operations.

A further inventive concept relates to expanding the information base by running the prior simulation method. The results obtained from the prior simulation (simulation results) constitute a unit of information corresponding to future status changes in the compressed air station, whereby even further basic conditions can also be factored in. The controller of the compressed air station can therefore not only access currently known process values but is also cognizant of future effects and conditions of control or switching operations already performed in the past or the present. At the same time, the prior simulation also allows information values to be generated which refer only to future switching strategies. The present control method is thus differentiated as a “proactive” control method in contrast to the “reactive” control methods known in the prior art. Only by running the prior simulation can virtual pressure events be defined which refer to events which occur in the prior simulation but are not triggered by current measurement values of the actual compressed air station. Averting undesired events in the compressed air station which will not occur until the future thus allows early, albeit not premature, control of the actual pressure conditions in the compressed air station.

In conjunction with at least one fixed performance criterion, the prior simulated method allows evaluating different alternative switching strategies to control the compressed air station. A plurality of switching strategy variants (in principle as many as desired) can hereby be calculated in the prior simulation so as to thus determine and evaluate the reaction of the compressed air station to prompted switching strategies. According to the definition of the performance criterion, the alternative switching strategy which delivers the comparatively most advantageous result under the predetermined basic conditions can be selected from the plurality of strategies. It is hereby not only possible to simulate the switching strategies fora predefined ensuing disconnecting time but the switching strategies can extend virtually as far as desired into the simulated future. Switching strategy consequences can moreover be processed in the simulation, allowing the evaluation of switching strategies which build upon one another. Apart from testing different switching strategies, different basic conditions can in addition also be simulated in advance. By varying the basic conditions, actuator switching strategies can for example be determined which will fulfill the conditions to the comparatively most advantageous extent (or at least satisfactorily) in the most possible expected scenarios.

In one advantageous embodiment of the method according to the invention, the prior simulation method for analyzing a respective switching strategy is performed in less time than the simulated interval and preferably in less time than the duration of a control cycle. Such a calculating speed enables a plurality of switching strategies in the prior simulation from which the comparatively most advantageous one can then be selected on the basis of a performance criterion.

In a further advantageous embodiment of the method according to the invention, the prior simulation method for respectively analyzing a switching strategy comprises optionally the variation over time of status variables contained in the model of the compressed air station for the duration of the prior simulation. The future development of the status variables allows enlarging the information base which in turn enables a more precise and improved control or regulating.

In a further preferred embodiment of the inventive method, the model of the compressed air station is based on a set of time-dependent and/or non-linear preferably structurally-varied differential equations, as well as reproducing discontinuities and/or reaction times in the response of the compressors and/or other further optional compressed air system devices, which insofar preferably also allows the effect of past events on the current status variables of the compressed air station to be determined. Structural variance here means that occasionally only one changing subset will be considered from the set of differential equations. This plays a role optionally in the reproducing of the discontinuities and/or reaction times in the performance of the compressors and/or optional compressed air system devices because their response in different operating states or when transitioning between different operating states usually can or must be characterized by different or changing differential equations. The respective differential equations to be considered can thereby be selected by the differential equation itself or by external default. Although the differential equations are time-dependent, non-linear and structurally-varied in a particularly preferred embodiment, these properties do not necessarily all need to be fulfilled together or simultaneously for all the differential equations. For example, instead of non-linear differential equations, a plurality of individual or periodic linear differential equations can also be used as an approximation, some differential equations can be time-dependent while others are not time-dependent, some differential equations can be linear while others are non-linear and/or some differential equations can always be factored in while others only periodically.

One advantageous embodiment of the inventive method can provide for a development of the different switching strategies to be calculated in discrete or continuous steps over a predetermined interval of time during the prior simulation method. The length of the time interval can thereby for example be predefined externally by an operator of the compressed air station or also fixedly parameterized. The length of the time interval can additionally also be adaptively adjusted to the compressed air station events. Hence, the controller allows regulating specific fluctuations in pressure conditions as typically occur over time in a compressed air station.

A further implementation of the control method can provide for the prior simulation to be performed over a predetermined period of time from 1 second to 1000 seconds, preferably from 10 seconds to 300 seconds. An interval of time of this length typically allows reliably determining the changes and fluctuations in pressure conditions caused by the instigation of switching strategies in the compressed air station as well as also ensures sufficient prior simulation intervals for most applications.

One preferred embodiment of the inventive method provides for the time interval of the prior simulation to be adaptively adjusted by an abort criterion on the basis of parameters and/or status variables of the compressed air station model, optionally from pressure events and/or recordings or prognoses of the compressed air consumption. This allows the duration of the prior simulation to be advantageously adapted to the development of the compressed air consumption and, as a consequence, a faster, respectively a more comprehensive, prior simulation.

A further embodiment of the method according to the invention provides for the switching strategies analyzed with the prior simulation method to include discrete or continuous changes of the operating mode of compressors and other optional compressed air station devices at the beginning, the end and/or any given points in time during the prior simulation interval. This thus allows the method according to the embodiment to factor in the changes in control or disturbance variables over a simulated interval and, as a consequence, allows a realistic consideration of these variables over time.

It can further be provided for the length of the simulated time interval of the prior simulation method to be determined as a function of the technical performance data of the compressor system and/or the current load of individual compressors and/or past load fluctuations. Depending on the configuration of the compressed air station, the length of the prior simulation can thereby be limited such that the necessary resources to calculate the results of the prior simulation can be used as advantageously as possible. The length of the simulated interval is preferably calculated such that it is longer than the shortest typically occurring load fluctuations of the compressed air station.

In accordance with the embodiment, it can moreover be provided that the prior simulation is performed in discrete steps of from 0.1 second to 60 seconds, preferably 1 second. Pursuant this increment, direct changes in the pressure conditions in the compressed air station can also be reliably detected with simultaneous economic use of the computational resources used by the controller, for instance after effecting a switching operation in the prior simulation.

In a further embodiment, the method of controlling a compressed air station can also be characterized by factoring in at least some of the discontinuities and/or reaction times in the response of the compressors and/or further optional compressed air system devices, optionally the delayed compressed air release and the additional energy consumption of the compressors, in conjunction with changes in their operating state during the prior simulation such that a separate consideration outside of the prior simulation in the controller is no longer absolutely necessary. The actuators within a compressed air station typically have reaction times ranging from between 1 second to several 10 seconds. Unlike with the known prior art control methods, it is possible to calculate the effective reaction times as well as other discontinuities in the present-case prior simulation and thus factor these variables into the switching operation calculations. A condition for being able to factor in reaction times, however, is that the model of the compressed air station employed contains the reaction time responses in parameterized form. It is therefore no longer necessary to factor in the actuator reaction times in the controller itself. Reaction times are resolved quasi automatically in the prior simulation results. On the one hand, this enables ascertaining whether the control operations performed in the past were sufficient to avert undesired pressure profiles while on the other, an analysis can be made as to whether the current control operations can actually positively influence the variation in time of the pressure conditions at all.

A further embodiment of the present control method can provide for factoring in different upper pressure values or lower pressure values as a group of alternative switching strategies as criterion for triggering a predefined switching strategy in the confines of the prior simulation method. As opposed to the conventional pressure band control known from the prior art, the pressure values in the present case are not fixed but rather can be adjusted to the conditions in the compressed air die station. The pressure values can additionally be determined by means of the prior simulation method itself. The defining of appropriate upper and lower pressure values can be determined from repeated prior simulations with respectively varying pressure values. If such pressure values are initially predefined, they can represent the specifying basis for calculating different simulations in which the pressure values themselves remain constant yet variables such as for example control parameters characterized by switching operations are changed. Thus a status change in the compressed air station not requiring a redefining of upper pressure values can be determined by the most advantageous switching strategy possible which only determines a predefined number of control operations characterizing control parameters in the prior simulation method.

A further development can moreover provide for factoring in different upper and/or lower pressure values as a group of alternative switching strategies for at least one predefined switch-off strategy or at least one switch-on strategy within the confines of the prior simulation method. Accordingly, a series of switch-off or switch-on strategies for the compressors of the compressed air station can ensue, by means of which a preferable averting of a future pressure event in the compressed air station can for example be determined in a simplified prior simulation at constant pressure values, respectively at least one constant pressure value.

A further embodiment can moreover provide for the at least one predefined switch-off strategy or the at least one predefined switch-on strategy to follow from a list of predetermined switch-off or switch-on sequences. The respective sequences for switching off or switching on for instance individual compressors or groups of compressors can thereby be based on heuristic findings or also on the results of numerical calculations. Restricting the limited variable space by defining switch-off and switch-on sequences can shorten the time needed to calculate the individual alternative switching strategies to a technically advantageous length.

A further embodiment moreover provides for the switching on or switching off of different groups of compressors at upper pressure values or lower pressure values either predefined or still to be determined in the prior simulation method to also be considered as a group of alternative switching strategies. The switching on or off of different groups of compressors can hereby again be based on heuristic findings or also on predetermined sequences established by numerical calculations. Switching on or off entire groups of compressors can have a more specific and sometimes longer impact on the change in pressure conditions in the compressed air station.

Another embodiment of the method for controlling a compressed air station can provide for the prior simulation method to be performed based on the theory of hybrid automata. Thus, there is a broad highly-efficient calculating basis for realizing the prior simulation method. In contrast to conventional calculating of exclusively digitally-based variables, performing the prior simulation method based on hybrid automata also enables analog variables such as e.g. real-time measured variables. The continuous measured variables do not thereby assume a value from a series of possible values but rather can be changed continuously and therefore require special treatment. Hybrid automata represent an extension of the concept of finite automata with which virtually any discrete system can be modeled.

Although it is not imperative to use hybrid automata to perform the inventive method, they are nevertheless a condition according to the embodiment for compiling the simulation model regarded as advantageous here.

A further development of the control method for controlling a compressed air station can also provide for the prior simulation method to be based on a computer-implementable and preferably deterministic model. This allows using the great many known computer-implemented algorithms and mathematical methods of numerical mathematics.

The method for controlling a compressed air station can be further characterized by the performance criterion being defined at the lowest possible consumption of energy or at least significantly determined therefrom. The energy consumption, which sometimes constitutes the greatest cost factor during compressed air station operation, can thus already be defined before any actual changes occur to the pressure conditions in the compressed air station and be applicably influenced by the selection of a criterion, for instance to reduce or lower energy consumption. The consequence of this can be a clear commercial viability to the operation of the compressed air station.

A further embodiment of the method for controlling a compressed air station can also provide for the prior simulation method to furnish at least one dataset of prognosticated future variations in time for the status variables of the model of the compressed air station in different switching strategies at different, not necessarily equally-spaced, time points and/or parameters derived therefrom, preferably for the entire control cycle. The creating of at least one such dataset for example allows the controller of the compressed air station to prompt corresponding switching strategies without the controller itself needing to use the prior simulation method as a direct control algorithm or part of a direct control algorithm. Instead, the prior simulation method can be implemented as an independent numerical model initialized and run by the controller as needed.

In another embodiment, the method for controlling a compressed air station can also comprise an automatic adaptation of the model of the compressed air station as needed to updated and/or initially only approximately known and/or inexactly set system parameters. This actualization ensures that at all times when the prior simulation method is run, suitable system parameters will be available for the entire time the compressed air station is in operation. In addition to ensuring more accurate prognoses, an automatic adapting of the model of the compressed air station in terms of updated system parameters can sometimes also result in increasing the speed of the prior simulation method.

Furthermore, the inventive method can also be characterized in that an embodiment adapting the model of the compressed air station can ensue with updated system parameters such that the system parameter which most closely matches the physically observed progression of the compressed air station's operation is selected from a plurality of alternative sets of system parameters in the subsequent simulation of the compressed air station operation for a past interval of time. This selection strategy can be additionally supported by sequential targeted changes in the operating state of respective individual compressors and/or compressed air station devices and that only alternative parameters of the respective compressor and/or device will be analyzed and selected during the subsequent simulation.

In accordance with the embodiment, it can also be provided for current variable system parameters of the compressed air station to be factored into the prior simulation method, optionally information on the operating state of at least one pressurized fluid tank, for example its pressure and/or its temperature and/or information on the operating status of individual compressors, for example their control status and/or current functional status and/or even information related to the change in the amount of pressurized fluid in the compressed air station, for example the reduction of pressurized fluid volume per unit of time. Factoring in current variable compressed air station system parameters results in a more complete and accurate calculation which results in a higher level of control quality.

The method of controlling a compressed air station can also be characterized by the prior simulation method factoring in information about the pressurized fluid supply volume for individual compressors and/or the consumption of individual compressors in different load states and/or information on the reaction times of the compressors and/or the characteristic minimum pressure or maximum pressure limits for the compressor system as fixed system parameters of the compressed air station. Factoring in the fixed compressed air station system parameters further allows a more detailed specification of the compressed air station itself as well as also important basic conditions for performing the prior simulation method and thus results in an improved prognosis of the pressure conditions in the compressed air station by the prior simulation.

The method for controlling the compressed air station can also ensure there are no changes to the configuration of the loaded compressors and the non-loaded compressors in the prior simulation of the compressed air station over the simulated interval of time of the prior simulation. Such a restricting of the possible variable space enables the prior simulation to run faster and, as a result, increases prognosis speed. It is hereby to be distinguished that the configuration of the loaded/non-loaded compressors of the compressed air station in the prior simulation do not need to match the current prevailing configuration of loaded/non-loaded compressors of the compressor system at the time the prior simulation is run. In fact, it can be crucial to include a configuration of loaded or non-loaded compressors which does not correspond to the actual current situation in a prior simulation so as to determine the comparatively most advantageous switching strategy for the compressed air station control.

The method for controlling a compressed air station can further provide for a pressure-equalizing compressor among the number of loaded compressors in the prior simulation which is selected pursuant the smallest compressor in terms of compressor power which, according to the prior simulation, exhibits the longest remaining life in an idle state if this compressor were to be converted in the prior simulation from a loaded compressor to a non-loaded compressor. The classification of compressors as loaded compressors and non-loaded compressors in the prior simulation ensues on the basis of process information and the parameterization stored in the control. To effect a further pressure equalization in the compressed air station, one compressor can be designated as the pressure-equalizing compressor to ensure a suitable actual pressure equalization in the future. This pressure-equalizing compressor is typically selected from among the loaded compressors in the prior simulation. Both predefined parameters as well as compressed air station process information (status parameter) can be used to select the pressure-equalizing compressor. Selecting the smallest compressor in terms of compressor power as the pressure-equalizing compressor from the plurality of loaded compressors in the prior simulation can additionally reduce the power consumption of the compressed air station and lower the costs of operating the compressed air station.

The method for controlling a compressed air station can furthermore provide for determining the lower pressure value in at least two prior simulations with the some parameterization but varying numerical values for the lower pressure value and the simulated time the lower pressure value is undercut. The lower pressure value is typically determined here only when the pressure-equalizing compressor is not currently loaded. Control of the pressure-equalizing compressor can hereby be assumed by an algorithm which processes the pressure values (lower pressure value and upper pressure value) which can always be adapted to the changing conditions in the compressed air station. In a stochastic method, different pressure values can be predefined and tested by the prior simulation method. The lower pressure value is typically determined only when the pressure-equalizing compressor is not currently loaded. Based on the prior simulation method, the anticipated time at which a previously parameterized minimum pressure for the compressed air station will be undercut can thus be determined. Pursuant heuristic rules, it can also be established when the pressure-equalizing compressor will be treated as a load compressor in the prior simulation method. If, for example, the compressor is in an idle state 5 seconds before the minimum pressure is undercut, then the lower pressure value is 5 seconds prior to undercutting the minimum pressure. If, on the other hand, the pressure-equalizing compressor is in a switched-off state 5 seconds before the minimum pressure is undercut, then the lower pressure value is 15 seconds prior to undercutting the minimum pressure. The interval of 5 seconds can thereby correspond to the approximate reaction time of a compressor for the status change from an idle state to a loaded state. The interval of 15 seconds can, on the other hand, correspond to the approximate reaction time of a compressor for the status change from a switched-off state to a loaded state.

The method for controlling a compressed air station can further be characterized by determining the upper pressure value in at least two prior simulations having the same parameterization but different numerical values for the upper pressure value and the pressure-equalizing compressor is then converted into a loaded compressor in the prior simulation when the pressure of the pressurized fluid in the compressed air station falls below the lower pressure value, and then converted into a non-loaded compressor when the pressure of the pressurized fluid in the compressed air station exceeds the upper pressure value. The upper pressure value is typically redefined prior to each prior simulation. A minimum as well as a maximum value can be predefined for the upper pressure value. The minimum value thereby typically corresponds to the lower pressure value. The maximum value of the upper pressure value can further yield from the maximum allowable pressure for the operation of the comprised air station. Should the pressure in the compressed air station for example exceed the maximum pressure, the pressure-equalizing compressor needs to switch off automatically.

All values between the minimum and maximum value for the upper pressure value are allowable pressure values in the prior simulation. Segmenting this pressure regime into for example equally-spaced pressure limits allows a predetermined number of upper pressure values to be analyzed by means of the prior simulation as to their suitable properties for controlling the compressed air station. It can be provided for the pressure value defined as the upper pressure value to be that with which the most stable pressure can be expected over the course of the simulated pressure conditions within the compressed air station. A further development of the method for controlling a compressed air station can provide for the prior simulation to determine a comparatively advantageous upper pressure value from all the upper pressure values set in the prior simulations and selecting all compressors as comparatively advantageous with respect to energy consumption in terms of the simulated energy consumption. Hence, just the appropriate selection of an upper pressure value alone makes a considerable contribution to reducing the operating costs of the compressed air station.

It is to be pointed out at this point that the upper as well as the lower pressure values are hereby not to be regarded as limits of an actual let alone fixed pressure band but rather as alternative upper or lower pressure values which can be “tried out” as triggers for switching operations respective the compressors at different and alternative switching times.

Additionally, it can be provided for the upper pressure value set in the prior simulation for determining an advantageous upper pressure value to be set in increments of from ≦0.5 bar, particularly in increments of ≦0.1 bar, whereby the increments of consecutively set or tried upper pressure values do not need to be at equal spacing, respectively the increments between the tested upper pressure values do not need to be constant. Such increments allow a reliable determining of that upper pressure value which can be classified as comparatively more advantageous. The increments here relate to working pressures or fluctuations in working pressures in industrially-used compressor systems.

A further development of the control method for controlling a compressed air station can provide for the prior simulation to use stochastic models for the consumer consumption over time in terms of withdrawing pressurized fluid from the compressed air station. The prior simulation can thus also factor in the withdrawal of pressurized fluid as approximately occurs during regular operation of the compressed air station.

An alternative embodiment can also provide for the prior simulation to use artificially intelligent and/or adaptive numerical routines for the consumer consumption over time in terms of withdrawing pressurized fluid from the compressed air station. This accordingly ensures a relatively precise determining of the consumer consumption after longer use of the compressed air station. Consumer consumption over time can thus be factored optionally advantageously.

A further embodiment of the inventive method provides for the technical programming of the method to be defined using object-oriented programming methods, whereby at least the compressors are regarded as objects. This accordingly enables particularly simple configuring of the design and implementing of the compressed air station model.

A preferred embodiment of the controller for a compressed air station uses separate hardware to realize the prior simulation which communicates with the controller via a bus system in a communication link with the compressors and other optional compressed air system devices.

In a further preferred embodiment of the inventive method, the heuristics to generate alternative switching strategies are realized by a model contained in the simulation model of a compressed air station controller, whereby the model of the controller is used in the simulation of the control and regulating of the simulated compressed air station and whereby alternative switching strategies are generated by input of alternative control and regulating parameters for the model of the controller from which the respectively comparatively most advantageous switching strategy to generate in the actual compressed air station is selected.

Further embodiments of the invention are set forth in the subclaims.

The following will make reference to the drawings in describing embodiments of the invention in great detail. Shown are:

FIG. 1 a schematic representation of a compressed air station comprising a controller in accordance with a first embodiment of the present invention,

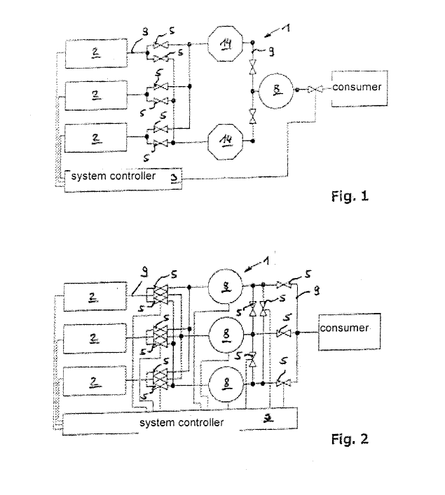

FIG. 2 a schematic representation of a compressed air station comprising a controller in accordance with a further embodiment of the present invention,

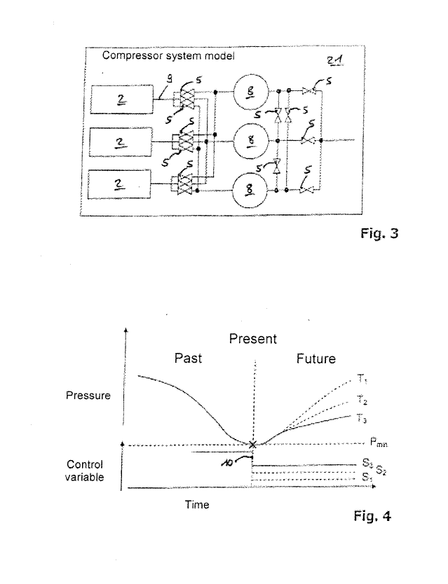

FIG. 3 a model of the compressed air station in accordance with the embodiment of the actual compressed air station in FIG. 2,

FIG. 4 a representation of the pressure variation in a compressed air station over time subject to the change of a control parameter by a control operation,

FIG. 5 a flow chart illustrating the method when using a prior simulation to control a compressed air station in accordance with an embodiment of the inventive method,

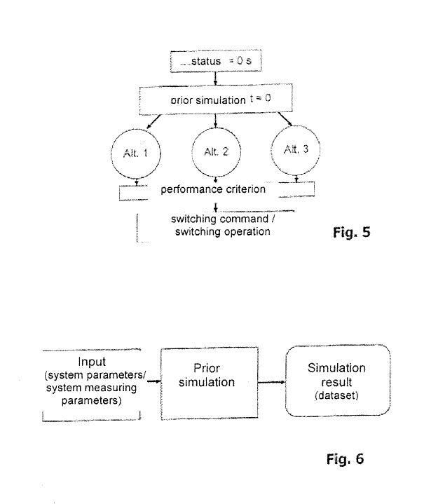

FIG. 6 a flow chart illustrating the use of a prior simulation in an embodiment of the control/regulating method according to the invention,

FIG. 7 a representation of the pressure variation of a compressed air station over time when using pressure band limits,

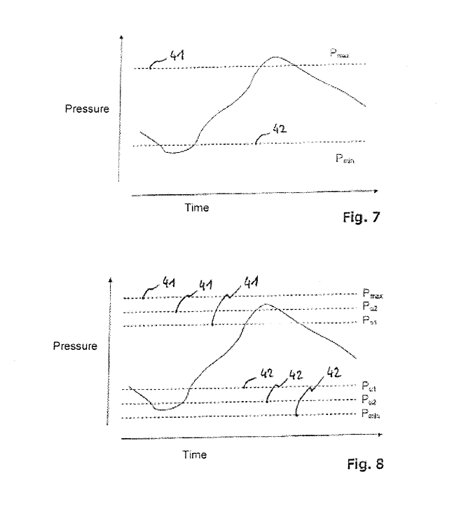

FIG. 8 a representation of the pressure variation over time in a compressed air station utilizing a pressure control method making use of three interconnected pressure bands,

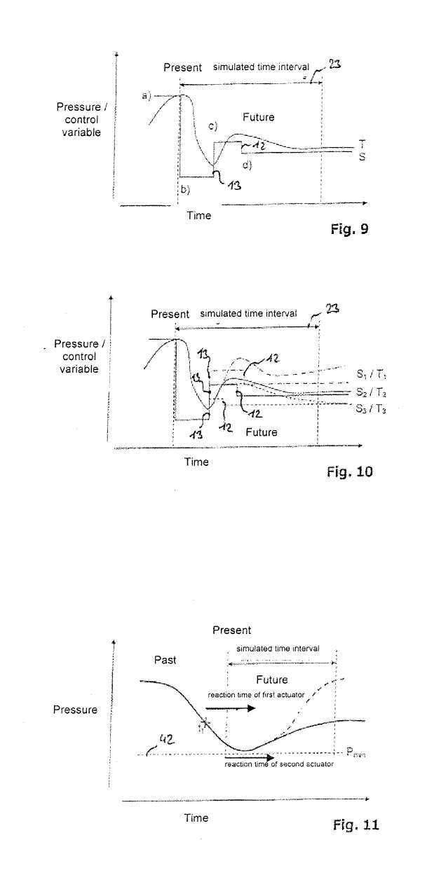

FIG. 9 the pressure development in a compressed air station over a future simulated interval of time in accordance with an embodiment of the invention with virtual changes in control parameters,

FIG. 10 the pressure development in a compressed air station over a future simulated interval of time in accordance with an embodiment of the invention with virtual changes in control parameters to determine a preferred switching strategy, and

FIG. 11 the pressure change in a compressed air station by means of a control method factoring in the reaction time of two control elements.

Identical or equivalent components are identified by the same reference numerals in the following description.

FIG. 1 shows a schematic representation of a first embodiment of a compressed air station 1 which interacts with a first embodiment of an inventive controller 3 which also controls or regulates same. The compressed air station 1 further comprises three compressors 2 which are connected to two compressed air dryers 14 by means of pressure lines 9 as well as actuators 5 configured as valves. The pressurized fluid 4 available to one or more consumers (not shown in the present figure) is stored in a pressurized fluid tank 8. In order for the controller 3 to be able to make the necessary control parameter changes, each actuator 5 can be activated by a connection to the controller 3 not indicated any further here. The functional principle of the controller 3 hereby essentially corresponds to the further somewhat more complex embodiment according to FIG. 2.

FIG. 2 shows a schematic representation of a somewhat more complex compressed air station 1 compared to the embodiment according to FIG. 1 which interacts with a controller 3 which controls or regulates same. In the controller 3, the compressed air station 1 comprises three compressors 2 provided to supply pressurized fluid 4 (not shown in the present figure) to three pressurized fluid tanks 8 upon the applicable control or regulating. The pressurized fluid 4 is thereby apportioned from each compressor 2 via a pressure line 9 to respectively three actuators 5, configured as valves 5 in the present case; which are in fluidic connection with the three pressurized fluid tanks 8 and which can supply each pressurized fluid tank 8 with pressurized fluid as needed. The pressurized fluid 4 can be withdrawn from the compressed air station 1 by a consumer, respectively a plurality of consumers, as needed. This withdrawal occurs at a receiving station (outlet point) not indicated any further here such that pressurized fluid 4 can be withdrawn from all the pressurized fluid tanks 8. According to the switching operations the controller 3 performs on the actuators 5, a specific pressurized fluid 4 can be routed from the pressurized fluid tank 8 to the receiving station to the consumer; plus pressure equalization is also possible among the individual pressurized fluid tanks 8. In order for the controller 3 to be able to make the necessary control parameter changes, switching strategies respectively, each actuator 5 can be activated by a connection to the controller 3 not indicated any further here. For reasons of clarity, the actuators 5 are not explicitly provided with a connection to the controller in the present case. However, it should be obvious to one skilled in the art that such a connection can be made. The control signals which the controller 3 transmits to the actuators 5 for switching operations can be of the most diverse type and can also be of both a discrete as well as a continuous nature. Typically common control signals for the actuators 5, optionally valves, can include switching off, switching on, or also only a gradual switching on/off. Controllable actuators 5 thus allow a connection to be made between the receiving stations of individual fluid tanks 8. Conceivable initiating actuators (e.g. pressure reducing valves) can furthermore be disposed between the pressurized fluid tank 8 and the receiving stations. Likewise conceivable is connecting a plurality of receiving stations to one compressed air station 1. The compressed air station 1 can moreover comprise sensors which detect changes over time in system status variables 56 (not shown in the present figure) and then provide them to the controller 3 for the control or regulating of the compressed air station 1. Thus, the pressurized fluid tanks 8 can for instance be provided with sensors, not indicated any further here, which enable the measuring of the pressure in the individual pressurized fluid tanks 8. The compressed air station 1 can furthermore also be provided with further sensors, not indicated any further here, which allow the determination of fluidic parameters to characterize the compressed air station 1.

FIG. 3 shows a model of the compressed air station as shown in FIG. 2 as used for example in a controller 3 to control the actual compressed air station. The controller 3 can hereby make use of a prior simulation method 20 (not shown in the present figure) in accordance with an embodiment of the present invention or also just typify a symbolic representation of a compressed air station 1 parameterization. If the model of the compressed air station 21 is used in a control or regulating method according to one embodiment of the invention, then each component essential to the operation of the compressed air station is characterized by a numerical parameterization. The format of this parameterization must be suitable for applicable use by the controller 3, respectively a prior simulation method 20 (not shown in the present figure). The parameterization can hereby not only ensue numerically but also by means of symbolic values, for instance by the specifying and selecting of compressor functional principles, designs, series or type designations.

FIG. 4 represents the pressure variation over time in the compressed air station 1, respectively a not further shown pressurized fluid tank 8, under the effect of a switching strategy 10 (switching operation, control parameter change). In this figure, the switching operation occurs at the present time. The switching strategy 10 is for example performed in order to correspondingly equalize the falling pressure in the compressed air station 1 from the past. It is clearly obvious here that upon the applicable switching action in the present, for example switching off a pressure control valve, there is an increase in the pressure in the compressed air station 1 over the course of the future. Depending on the magnitude of the control parameter change, there will be a lesser or greater increase in pressure in the future. A lesser control parameter change S₃ will result in a future pressure profile identified as T₃. In accordance with the control parameter change S₂, there will be a future pressure profile T₂, and in the case of control parameter change S₁, the pressure profile will follow the curve T₁. All three control parameter changes S₁, S₂ and S₃ are suited to prevent a decrease in pressure below a predefined minimum pressure Pₘᵢₙ. According to a determining decisive criterion, it is now the task of the controller 3 to decide which control parameter change would be suited to effecting a future desired pressure profile. Such a decisive criterion in the present example could for example account for the controller 3 regarding the profile of the solid-line control parameter change S₃ as being the preferred switching strategy 10.

The selection of a preferred switching strategy 10 according to the present inventive method to control a compressed air station also ensues by means of a prior simulation.

FIG. 5 is a flow chart of such a prior simulation selection method. Here a prior simulation method (prior simulation) is initialized at Time t=0 s (present) with the status variables which express the current status of the compressed air station 1. The prior simulation method starts immediately after initialization t≈0 s (i.e. a point in time which can still be identified as present within the scope of the simulation time period) and after the method is finished, respectively after a plurality of prior simulation methods 20 with different output parameters, same returns three alternative switching strategies 11 (Alt.1, Alt.2 and Alt.3) in the present case from which the applicable alternative switching strategy 11 will be selected on the basis of a performance criterion 22 to prompt the controller to trigger a switching command 30 to generate a switching strategy 10. In accordance with the embodiment, the alternative switching strategies 11 can result in future and predicted profiles of the pressure in the compressed air station 1 as for instance in the pressure profiles T₁, T₂ and T₃ of the FIG. 4 pressure profile.

FIG. 6 shows a further flow chart to illustrate a dataset 6 which contains the simulation results of the prior simulation 20. As already explained with respect to FIG. 5, a preferred switching strategy 10 can be determined in an embodiment of the inventive control method from the dataset 6 by means of a performance criterion 22. Input of system-relevant parameters are required to initialize a prior simulation or also a succession of prior simulations. System-relevant parameters can on the one hand be fixed system parameters 55 which comprise for example information on the amount of pressurized fluid supplied to the individual compressors or on the capacities of the individual compressors under different load conditions, information on the reaction times of compressors or actuators, as well as also characteristic minimum pressure and maximum pressure limits for the compressed air station. System-relevant parameters can furthermore also consist of system status variables 56 which depict changing variables over time. Such system-relevant parameters 56 of the compressed air station 1 can comprise information on the operating state of at least one pressurized fluid tank 8 or its pressure, its temperature, or they can include information on the operating status of individual compressors 2 as well as their current control or functional states, or even information related to the change in the amount of pressurized fluid 4 in the compressed air station 1 such as for example the change in pressurized fluid per unit of time, its flow or other physical parameters. The quality of the prior simulation 20 is based on the quality or number of fixed system parameters 55 and system status variables 56 on which the prior simulation 20 is based.

FIG. 7 shows the representation of the pressure variation of a compressed air station in terms of a pressure band which defines a lower pressure band limit 42 by a minimum pressure Pₘᵢₙ as well as an upper pressure band limit 41 by a maximum pressure Pₘₐₓ. When using a single predefined fixed pressure band to control a compressed air station 1, as for instance in a sequential control as known in the prior art, a corresponding switching operation occurs upon the pressure profile departing from the pressure band. Hence, the pressure profile for the pressure band falling short of the lower pressure band limit 42 can prompt a switching operation which readies an additional compressor to supply pressurized fluid. Such a switching operation is prompted at that point in time at which the pressure profile departs from the lower pressure band limit 42, whereby the supply of additional pressurized fluid ensues in such a manner that shortly after the undercutting, the pressure profile is again within the limits of the fixed predetermined pressure band. On the other hand, when the pressure profile departs from the upper pressure band limit 41, the pressure profile can be corrected for example by means of a switching-off operation at the time the upper pressure band limit 41 is exceeded such that shortly after the exceeding, it is again within the limits of the pressure band.

In terms of being able to influence the technical control of the pressure profile in the compressed air station 1 before the minimum pressure Pₘᵢₙ is undercut or the maximum pressure Pₘₐₓ is exceeded, additional interconnected pressure bands can also be defined in the calculations for prompting the switching operations. Hence, FIG. 8 shows for instance the pressure profile of a compressed air station 1 relative to three interconnected pressure bands. The lowest pressure band with the lower pressure limit 42 of P_{U1} and the upper pressure limit 41 of pressure P_{O1} are situated within the next higher pressure band with the lower pressure limit 42 of P_{U2} and the upper pressure limit 41 of pressure P_{O2}. Both predesignated pressure bands are then within the highest pressure band exhibiting a lower pressure limit 42 of Pₘᵢₙ as well as a maximum pressure for the upper pressure band limit 41 of Pₘₐₓ. In order to now prevent the pressure profile from departing beyond the pressure band limits of the highest pressure band, the controller 3 (not shown in the present figure) can prompt switching operations right at those points in time at which the pressure profile exceeds the pressure band limits of the lowest or next higher pressure band. Due to the immanent delay times in the compressed air station after prompting a switching operation, an adjustment of the pressure profile will occur after a correspondingly short interval of time.

The pressure profiles shown in FIGS. 7 and 8 result from switching operations prompted by purely reactive control methods. A corresponding switching operation is prompted only when a predetermined pressure event occurs (for example departing from the pressure band limits). In contrast hereto, pursuant the present invention, switching strategies are simulated for the future in order to set a desired pressure profile.

FIG. 9 shows just such a simulation over a future-simulated time interval 23. To this end, a switching strategy 10 is effected at a present point in time which lowers the control parameter from a value a) to a lower value b). The expected future course of the pressure in the compressed air station follows a slightly delayed drop-off, In order to prevent a pressure drop below a predetermined value or to set a stable pressure profile, a virtual change to the control parameter from the value b) to the higher value c) is made at a future point in the prior simulation. This virtual control parameter change results in a virtual increase in the pressure of the compressed air station 1. For example, the virtual control parameter change can be within a switching strategy 13 for a compressor. However, in order to prevent an excessively large virtual increase in pressure, a further control parameter change is made at a later simulated point in time from the value c) to the value d). This second virtual control parameter change to the value d) can be within a switching strategy 12, for example. Combining both virtual control parameter changes enables a stable virtual pressure profile to be set by the end of the simulated time interval 23. Now making these two virtual control parameter changes actual switching strategies 10, for example at the corresponding time points in the real future, allows the expectation of a set stable pressure profile. Performing the prior simulation can thus quasi predict the future behavior of the compressed air station and expand the information base on compressed air station status to future points in time.

Compared to the pressure profile depicted in FIG. 9, FIG. 10 depicts three possible virtual pressure profiles as would result from different control parameter changes over the simulated interval of time 23 pursuant the prior simulation 20. Depending upon the virtual switching strategies 13, switching-off strategies 12 respectively, stable or rising/falling pressure profiles result by the end of the simulated time interval 23. It is to be mentioned here that the virtual switching strategies 10 performed in the different simulations can also occur at different points in time. The different control parameter changes can moreover also be influenced by one or more consumers withdrawing pressurized fluid from the compressed air station 1. This accordingly results in the effect of switching operations identified as S₁ being a rising pressure profile T₁ at the end of the simulated time interval 23. The effect of switching operations identified as S₂ results in a largely stable pressure profile in the compressed air station 1 by the end of the simulated time interval 23. The effect of switching operations identified as S₃ results in a falling pressure profile T₃ at the end of the simulated time interval 23. If that pressure profile which exhibits the comparatively lowest fluctuations at the end of the simulated time interval 23 is selected from among the three possible simulated pressure profiles by means of a performance criterion 22 (not specified here), the prior simulation 20 performed then suggests running the switching operations 10 according to the succession of switching operations identified as S₂ at the corresponding future point in time. As would be understandable to one skilled in the art, by varying numerous further parameters in the prior simulation, numerous possible virtual pressure profiles can also be generated from which the best can then be selected based on a performance criterion 22.

Implementing a prior simulation method 20 enables calculating the effective reaction times of the elements utilized in the compressed air station 1 in the simulation and implicitly incorporating them when calculating the time points at which switching strategies 10 are to run. A prerequisite hereto, however, is for the models of the compressed air station 21 employed to contain the reaction time responses. It is thus no longer necessary for the controller 3 to explicitly factor in the reaction times of individual actuators 5. Actuators 5 can hereby also be incorporated by compressors 2 and further optional devices of the compressed air station which can be controlled for instance by the applicable control signals for the purpose of control parameter change. Actuators 5 are thus not just limited to external valves S as depicted in FIG. 2. Reaction times are automatically circumvented by means of the prior simulation generated. This enables on the one hand ascertaining whether the control parameter changes performed in the past were sufficient to avert undesired events and, on the other, allows analyzing whether control parameter changes initiated in the present will have any additional positive impact at all on the pressure profile over time.

FIG. 11 depicts the pressure profile of a compressed air station 1 over a course of time. In the Past, a first actuator switching operation was made here in this present example at time point T1. Due to the reaction time of the first actuator 5, the effect of this switching operation is not yet discernible in the pressure profile of the Present. Therefore, there is the possibility of performing a further switching operation on a second actuator in the Present. However, not until the future pressure profile is simulated can a decision be made as to whether the switching operation on the second actuator will improve how well a basic condition is fulfilled (e.g. avoiding undercutting of the minimum pressure Pₘᵢₙ) or even be necessary at all. If the prior simulation is performed for both possible switching strategies over the simulated time interval 23, it becomes evident that the switching operation on the second actuator 5 is not necessary in order to ensure compliance with the basic conditions. It can additionally be recognized that the reaction time of the second actuators 5 is not circumvented until the pressure of the compressed air station 1 is already clearly above the minimum pressure Pₘᵢₙ. Accordingly, based on the prior simulation method 20 performed, the decision can be made that no switching operation should be performed on the second actuator to improve the pressure profile in the compressed air station 1.

It is to be noted at this point that all of the above described components, whether alone or in any combination, are claimed as being essential to the invention, optionally the details depicted in the drawings. Variations thereof will be familiar to those skilled in the art.

### REFERENCE NUMERALS

1 compressed air station
2 compressor
3 system controller
4 pressurized fluid
5 actuator
6 dataset
8 pressurized fluid tank
9 pressure line
10 switching strategy
11 alternative switching strategy
12 switch-off strategy
13 switch-on strategy
14 compressed air dryer
20 prior simulation method
21 compressor system model
22 performance criterion
23 time interval
30 switching command
41 upper pressure band limit
42 lower pressure band limit
54 pressure-equalizing compressor
55 system parameter
56 system status variables
60 hardware
61 bus system
70 simulation kernel
71 algorithm kernel
72 information base

1. A method for controlling a compressed air station including at least a plurality of interconnected compressors, each compressor optionally having a different technical specifications, and further specification, the compressed air station including a system controller configured to implement control cycles as well as switching strategies influence an amount of a pressurized fluid in the compressed air station available to one or more consumers of the compressed air station and to adaptively adjust the amount of pressurized fluid available to one or more consumers of the compressed air station to operating conditions of the compressed air station at a future time period based on an amount of pressurized fluid withdrawn from the compressed air station, the method comprising the steps of:
analyzing a plurality of switching strategies using a simulation method based on a model of operation of the compressed air station during a time interval prior to the future time;
selecting, from the plurality of switching strategies, a comparatively most advantageous switching strategy based on at least one fixed performance criterion; and
initiating the switching strategy.

2. The method according to claim 1, wherein at least one of predetermined upper pressure limits and predetermined lower pressure limits are used by the simulation method, as conditions to be maintained.

3. The method according to claim 1, wherein the simulation method for analyzing the plurality of switching strategies is performed faster than a simulated time interval in a time period that is shorter than a duration of a control cycle.

4. The method according to claim 1, wherein the simulation method for analyzing a the plurality of switching strategies includes status variables contained in the model of operation of the compressed air station for the time interval of the simulation.

5. The method according to claim 1, wherein the model operation of the compressed air station is based on a set of differential equations that are at least one of time-dependent, non-linear, and structurally-varied to reproduce at least one of discontinuities and reaction times in a response of the compressors which allows an effect of past events on current status variables of the compressed air station to be determined.

6. The method according to claim 1, wherein the plurality of switching strategies are analyzed in discrete or continuous steps over the time interval of the simulation method.

7. The method according to claim 1, wherein the time interval of the simulation method is a predetermined time interval selected from a range of 1 second to 1000 seconds.

8. The method according to claim 1, wherein the time interval of the simulation method is adaptively adjusted by an abort criterion on the basis of at least one of parameters and status variables of the model of the compressed air station.

9. The method according to claim 1, wherein the plurality of switching strategies analyzed using the simulation method include discrete or continuous changes of an operating mode of the compressors at any of a plurality of points in time during the priertime interval of the simulation method.

10. The method according to claim 1, wherein a length of the time interval of the simulation method is determined as a function of at least one of technical performance data of the compressors of the compressor system, a current load of individual compressors, and past load fluctuations.

11. The method according to claim 1, wherein the simulation is performed in discrete intervals ranging from 0.1 second to 60 seconds.

12. The method according to claim 1, wherein at least one of discontinuities reaction time, and changes in operating state in a response of the compressors are considered during the simulation method.

13. The method according to claim 1, wherein the plurality of switching strategies analyzed in the simulation method include a plurality of different upper pressure values or lower pressure values.

14. The method according to claim 1, wherein the plurality of switching strategies analyzed in the simulation method include a plurality of different upper pressure values or lower pressure values for at least one of the interconnected compressors.

15. The method according to claim 14, wherein at least one predefined switch-off strategy or at least one predefined switch-on strategy follows from a list of predetermined switch-off or switch-on strategies.

16. The method according to claim 1, wherein the plurality of switching strategies analyzed in the simulation method include a switching on or a switching off of different compressor groups at upper pressure values or lower pressure values that are one of predefined or undefined in the simulation method.

17. The method according to claim 1, wherein the simulation method is implemented based on a theory of hybrid automata.

18. The method according to claim 1, wherein the simulation method is implemented based on a computer-implementable and deterministic model.

19. The method according to claim 1, wherein the performance criterion is associated with a lowest possible consumption of energy.

20. The method according to claim 1, wherein the simulation method produces at least one dataset of predicted future variations in time for status variables of the model of the compressed air station in different switching strategies at different time points or derived parameters for an entire control cycle.

21. The method according to claim 1, further comprising automatically adapting the model of the compressed air station to updated approximately known or inexactly set system parameters.

22. The method according to claim 21, wherein an adaptation of the model of the compressed air station ensues with updated system parameters such that a set of system parameters, with which the simulation of the operation of the compressed air station for a past interval of time most closely matches a physically observed progression, is selected from a plurality of alternative sets of system parameters.

23. The method according to claim 22, wherein sequentially selective changes to an operating status of the respective individual devices of the compressed air station are implemented to support the adaptive adjusting of individual model parameters to changed system parameters.

24. The method according to claim 1, wherein current variable system parameters of the compressed air station can be utilized by the simulation method, the current variable system parameters including information on an operating state of at least one pressurized fluid tank comprising a pressure or temperature; information on an operating status of individual compressors comprising control status or current functional status; or information related to a change in an amount of pressurized fluid in the compressed air station, comprising a reduction of pressurized fluid volume per unit of time.

25. The method according to claim 1, wherein information about a supply volume of the pressurized fluid for individual compressors or consumption of individual compressors in different load states information on reaction times of the compressors, or characteristic minimum pressure or maximum pressure limits for the compressed air station are utilized by the simulation method as fixed system parameters of the compressed air station.

26. The method according to claim 1, wherein a configuration of loaded compressors and non-loaded compressors of the compressed air station remains the same in a simulation over a simulated time interval.

27. The method according to claim 1, wherein a smallest compressor based on compressor power is selected as a pressure-equalizing compressor from a plurality of loaded compressors which, according to a simulation, exhibit a longest remaining life in an idle state if the smallest compressor is converted from a loaded compressor to a non-loaded compressor.

28. The method according to claim 13, wherein at least two simulations having a same parameterization and varying numerical values for the lower pressure value are performed to determine the lower pressure value of the compressed air station and a simulated time that the lower pressure value is undercut.

29. The method according to claim 28, wherein at least two prior simulations having a same parameterization and varying numerical values for an upper pressure value are performed to determine the upper pressure value of the compressed air station, and wherein the pressure-equalizing compressor is then converted into a loaded compressor if the pressure of the pressurized fluid in the compressed air station falls short of the lower pressure value, and the pressure-equalizing compressor is converted into a non-loaded compressor when the pressure of the pressurized fluid in the compressed air station exceeds the upper pressure value.

30. The method according to claim 29, wherein the determined upper pressure value in the at least two simulations is derived from upper pressure values set in the at least two simulations and selected based on simulated energy consumption of the plurality of compressors.

31. The method according to claim 29, wherein the upper pressure values set in the simulation method are set at ≦0.5 bar, wherein the tested upper pressure values do not need to be at equal spacing.

32. The method according to claim 1, wherein the simulation uses stochastic models of consumers withdrawing pressurized fluid from the compressed air station.

33. The method according to claim 1, wherein the simulation method uses artificially intelligent or adaptive numerical routines for simulating consumers withdrawing pressurized fluid from the compressed air station.

34. The method according to claim 1, wherein the method is embodied as a program stored on a non-transitory computer readable medium, the program using object-oriented programming methods, and wherein at least the compressors are regarded as objects.

35. A compressed air station comprising:
a plurality of interconnected compressors, each compressor having a different technical specification; and
an electronic controller that processes information about compressed air station status variables as input information and outputs control commands as output to control at least some of the plurality of compressors, the electronic controller including:
a simulation kernel that contains dynamic non-linear models of at least some components of the compressed air station in order to specify a response of these components, wherein the simulation kernel being configured to precalculate a variation of the status variables of the components of the compressed air station contained in a model over time as simulation results based on alternative switching strategies, the models of the simulation kernel utilizing at least one of essential nonlinearities, discontinuities, or reaction times of component response, including at least that of the compressors;
an algorithm kernel that contains parameters to characterize the components of the compressed air station, topology information on a circuitry of the individual components, heuristics for configuring alternative switching strategies, and evaluation criteria for a variation over time in the status variables of the components of the compressed air station as determined by the simulation kernel for the alternative switching strategies, wherein the algorithm kernel selects the comparatively most advantageous switching strategy and either holds ready or relays associated control commands to at least some of the compressors; and
a database that contains a process image provided by sensor values and the algorithm kernel, and simulation results for switching strategies, the database representing at least a portion of a common database of the algorithm kernel and simulation kernel and serving in an exchange of data between the algorithm kernel and the simulation kernel.

36. The system according to claim 35, wherein heuristics to configure alternative switching strategies are realized in a model of a system controller for a compressed air station contained in a simulation model which assumes the control and regulation of the simulated compressed air station in the simulation, the alternative switching strategies are generated by inputting alternative control and regulating parameters for the model of the system controller from which a switching strategy to initiate in the actual compressed air station is selected.

37. A compressed air station comprising:
a plurality of interconnected compressors, each compressor having a different technical specification and
a system controller configured to implement one or more control cycles and one or more switching strategies of one or both of (i) control elements of the compressed air station and (ii) the plurality of interconnected compressors to influence an amount of a pressurized fluid in the compressed air station available to one or more consumers of the compressed air station and to adaptively adjust the amount pressurized fluid available to one or more consumers of the compressed air station to operating conditions of the compressed air station in a future period based on an amount of pressurized fluid withdrawn from the compressed air station;
wherein the switching strategy to be implemented by the system controller is selected by analyzing a plurality of different switching strategies using a simulation based on a model of operation of the compressed air station in a prior period and selecting from the plurality of different switching strategies a comparatively most advantageous switching strategy based on at least one fixed performance criterion.

38. The compressed air station according to claim 37, wherein hardware is used to implement the simulation, the hardware in communication with the system controller via a bus system in a communication link with the compressors.

39. The method according to claim 7, wherein the time interval of the simulation method is a predetermined time interval selected from a range of 10 seconds to 300 seconds.

40. The method according to claim 8, wherein the at least one of parameters and status variables comprise pressure events and recordings or prognoses of compressed air consumption.

41. The method according to claim 1 wherein the simulation is performed in 1 second intervals.

42. The method according to claim 1 wherein a delayed compressed air release and an additional energy consumption of the compressors is considered during the simulation method.

43. The method according to claim 29, wherein the upper pressure values set in the simulation method are set at increments of 0.1 bar, wherein the tested upper pressure values do not need to be at equal spacing.
